(19) United States
(12) Patent Application Publication
(10) Pub. No.: US 2009/0323075 A1
(43) Pub. Date: Dec. 31, 2009

(54) FLEXURAL DISC FIBER OPTIC SENSOR

(75) Inventor: Dominic Brady, Southampton (GB)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/375,021

(22) PCT Filed: Jul. 12, 2007
(86) PCT No.: PCT/GB07/02605

§ 371 Date: May 21, 2009

(30) Foreign Application Priority Data
Jul. 25, 2006 (GB) 0614716.9

(51) Int. Cl. G01P 15/093

(52) U.S. Cl. 356/477

(57) ABSTRACT

A fiber optic sensor employs a central support structure and at least two flexural discs spaced apart from one another along a central axis. Radially-inner portions of the flexural discs are rigidly attached to the central support structure. A fiber optic coil is affixed to one of the flexural discs. At least one proof mass is disposed between the flexural discs. Coupling means rigidly connects together radially outer edge portions of the flexural discs and rigidly connects the at least one proof mass to such outer edge portions. The flexibility of the axially-aligned outer-edge-connected flexural disc arrangement, together with the outer-edge-connected proof mass, provide for a relatively large response to axial forces. The radial stiffness of the axially-aligned outer-edge-connected flexural disc arrangement minimizes the response to non-axial forces. By limiting the response to non-axial forces, unwanted cross-axis sensitivity of the device is reduced and unwanted resonances are eliminated. The seismic mass may comprise a tungsten body.

### BACKGROUND OF THE INVENTION

1. Field of the Invention

This invention relates broadly to fiber optic sensors for measuring linear acceleration. More particularly, this invention relates to fiber optic sensors that employ an optical fiber coil affixed to a flexural disc.

2. Description of Related Art

The flexure or strain of an optical fiber coil affixed to a flexible disc is a well-known basis for measuring acceleration resulting from momentum forces acting on the disc in a direction normal to the disc. The amount of flexure is determined interferometrically, where interferometric measurements of strain in the optical fiber coil provide high resolution, high data rates, require low power, are immune to electromagnetic interference, and can readily be adapted for remote sensing and/or rugged applications.

The mass which provides the inertia and hence the force to cause flexure of the disc usually consists of the disc itself and the optical fiber coil affixed thereto. This mass is typically small. As a result, the sensitivity of the strain measurements is poor although the response extends to high frequency. Additional mass can be coupled to the disc in order to improve the sensitivity of the strain measurements at the expense of frequency response. For example, U.S. Pat. Nos. 6,384,919 and 5,369,485 each describe a flexural disc fiber optic sensor having a center-supported flexural disc with additional mass that is affixed to the outer edge of the disc and disposed outside the outer circumference of the disc. US Patent Application 2005/0115320 describes a flexural disc fiber optic sensor having a center-supported flexural disc with additional mass that is affixed to the outer edge of the disc and disposed above and below the outer portion of the disc. Such additional mass improves the sensitivity of the device by increasing the axial deformation of the flexural disc for a given acceleration. However, such additional mass can also cause unwanted effects, including increased cross-axis sensitivity (i.e., deformation of the flexural disc under any non-axial acceleration). Such cross-axis sensitivity can lead to measurement inaccuracies and thus render such prior art fiber optic sensor designs impractical for many applications that require high sensitivity.

Moreover, the prior art fiber optic sensors are also generally impractical for applications requiring a flat frequency response up to several kHz (due to unwanted resonance frequencies in this range) as well as for applications requiring a small, compact footprint and package volume that is easily configured in an array (i.e., easy to multiplex).

Thus, there remains a need in the art for a flexural disc fiber optic sensor that provides high sensitivity to axial accelerations together with reduced sensitivity to off-axis accelerations, a flat frequency response up to several kHz, and a small, compact design that is easily configured in an array (i.e., easy to multiplex).

### BRIEF SUMMARY OF THE INVENTION

The invention provides a flexural disc fiber optic sensor that provides high sensitivity to axial accelerations together with reduced sensitivity to off-axis forces.

The invention also provides such a flexural disc fiber optic sensor that has a flat frequency response up to several kHz free of unwanted resonances.

The invention further provides a flexural disc fiber optic sensor that has a small, compact design and can be easily configured in an array, which thus makes it suitable for installation in a borehole that traverses an oilfield.

Thus, as will be discussed in detail below, a fiber optic sensor employs at least two flexural discs that are spaced apart from one another along a central axis. A fiber optic coil is affixed to one of the flexural discs. A proof mass is disposed between the flexural discs. Radially inner portions of the flexural discs are rigidly connected to a central support structure. Radially outer edge portions of the flexural discs are rigidly connected to one another and to the proof mass. Each flexural disc is thin and flexible to allow for flexure of the disc between its inner and outer edges in response to axial forces, but is quite stiff in its radial direction (i.e., in the plane of the respective flexural disc).

It will be appreciated that the flexibility of the axially-aligned, outer-edge-connected flexural discs together with the outer-edge-connected proof mass provide for a relatively large response to axial forces, while the radial stiffness of the axially-aligned outer-edge-connected flexural discs minimizes the response to non-axial forces. By limiting the response to non-axial forces, unwanted cross-axis sensitivity of the device is significantly reduced.

The fiber optic sensor can be used for Optical Time Domain Reflectometry (OTDR) measurements of acceleration over spaced-apart locations in a fiber optic waveguide, which can be installed in a borehole that traverses an oilfield for real-time oilfield monitoring applications. Such OTDR measurements can also be used in fiber-based interferometric measurement applications.

Additional advantages of the invention will become apparent to those skilled in the art upon reference to the detailed description taken in conjunction with the provided figures.

### BRIEF DESCRIPTION OF THE DRAWINGS

FIG. 1A is a cross-section schematic view of an exemplary fiber optic sensor in accordance with the present invention.

FIG. 1B is a cross-section schematic view of another exemplary fiber optic sensor in accordance with the present invention.

### DETAILED DESCRIPTION OF THE INVENTION

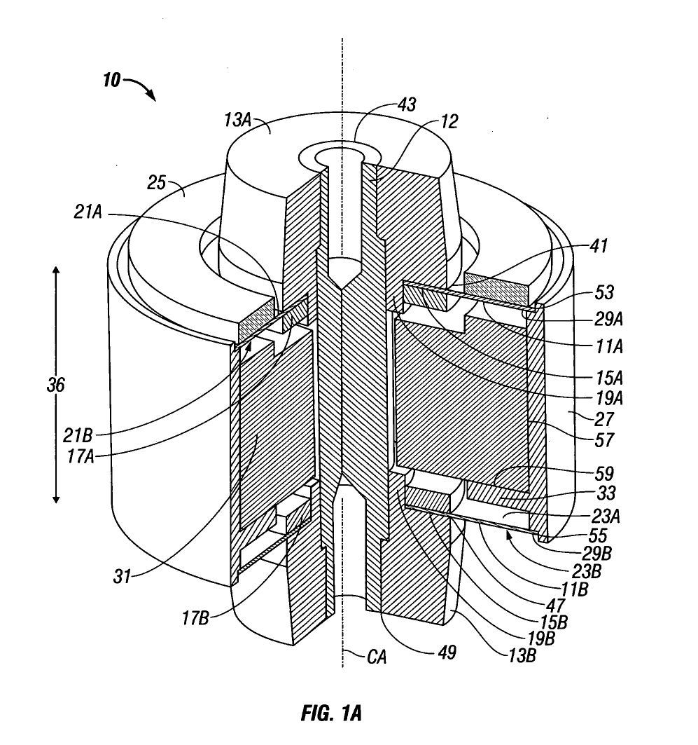

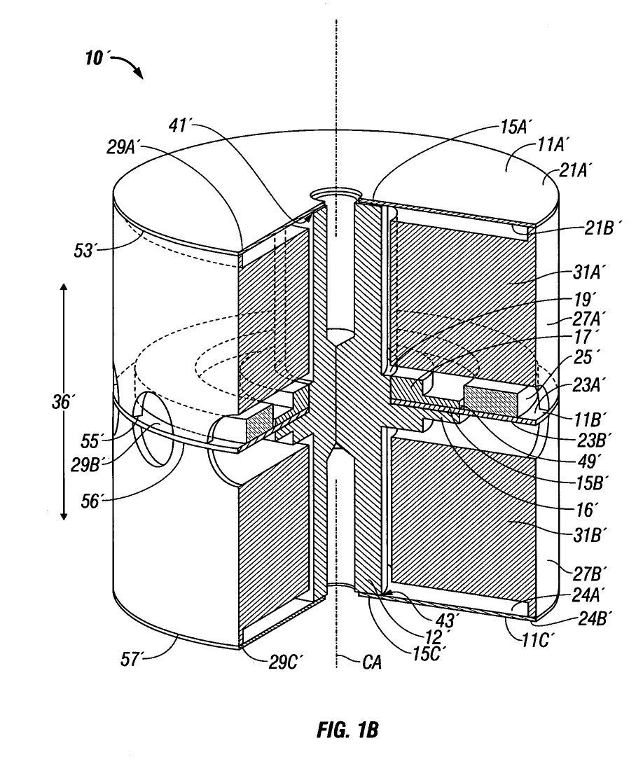

Turning now to FIG. 1A, a fiber optic sensor 10 according to the present invention includes a top flexural disc 11A and a bottom flexural disc 11B that are rigidly attached to a central support structure (e.g., the center post 12 and corresponding central support members 13A, 13B). In a first embodiment, the radially inner portion 15A of the top flexural disc 11A is permanently affixed between the central support member 13A and a backing disc 17A by welding, adhesive material, or other suitable means (for example, by welding along the interface 41 through the radially inner portion 15A of the top flexural disc 11A to the central support member 13A). The backing disc 17A interfaces to an annular flange portion 19A of the central support member 13A. The central support member 13A is rigidly attached to the center post 12 by welding, adhesive material, or other suitable means (for example, by welding along an interface 43 therebetween adjacent the top wall of the central support member 13A).

Similarly, the radially inner portion 15B of the bottom flexural disc 11B is permanently affixed between the central support member 13B and a backing disc 17B by welding, adhesive material, or other suitable means (for example, by welding along the interface 47 through the inner radial portion 15B of the bottom flexural disc 11B to the central support member 13B). The backing disc 17B interfaces to an annular flange portion 19B of the central support member 13B. The central support member 13B is rigidly attached to the center post 12 by welding, adhesive material, or other suitable means (for example, by welding along an interface 49 therebetween in the bottom wall of the central support member 13B). In this configuration, the top and bottom flexural discs 11A, 11B are centrally supported by rigid attachment to the central support structure (central support members 13A, 13B and the center post 12) such that the top and bottom flexural discs 11A, 11B are axially-aligned to one another.

The top flexural disc 11A has a top surface 21A opposite a bottom surface 21B. Similarly, the bottom flexural disc 11B has a top surface 23A opposite a bottom surface 23B. A fiber optic coil 25 is affixed to the top surface 21A of the top flexural disc 11A by adhesive material or other suitable means. For simplicity of illustration, the fiber optic coil 25 is indicated as a solid component. However, it should be understood that the fiber optic coil 25 is a multi-layer, spiral-wound coil that may be formed in accordance with well-known techniques for forming such coil. The change in optical path length of the fiber optic coil 25 may be measured by any of a number of techniques well known to those of skill in the art, such as white light interferometry or interrogation in the time domain. Optionally, reflectors, such as fiber Bragg gratings may be incorporated into the fiber optic coil near its start and end points to prevent perturbations on the interrogation system optical fiber external to the fiber optic sensor 10 interfering with the sensor measurements.

An outer edge coupler 27 extends between the radially outer edge portions 29A, 29B of the flexural discs 11A, 11B and is rigidly attached thereto by welding, adhesive material, or other suitable means (for example, welding at interfaces 53, 55) such that the radially outer edge portions 29A, 29B of the top and bottom flexural discs 11A, 11B are rigidly connected together. A proof mass 31, which is preferably made of tungsten, is rigidly attached to the outer edge coupler 27 and is disposed in the space between bottom surface 21B of the top flexural disc 11A and the top surface 23A of the bottom flexural disc 11B. Preferably, the outer edge coupler 27 includes a flange 33 that extends radially inward between the two flexural discs 11A, 11B. The proof mass 31 is supported by the flange 33 in the space between bottom surface 21B of the top flexural disc 11A and the top surface 23A of the bottom flexural disc 11B. The proof mass 31 is rigidly attached to the flange 33 by adhesive material, welding, soldering, brazing, or other suitable means (for example, by adhesive material at the interfaces 57, 59). In this manner, the proof mass 31 is rigidly connected by the outer edge coupler 27 to the radially outer edge portions 29A, 29B of the flexural discs 11A, 11B. The additional mass provided by the outer-edge-coupled proof mass 31 improves the sensitivity of the device in response to axial accelerations and the strain measurements based thereon.

The fiber optic coil 25 of the fiber optic sensor 10 is optically coupled (preferably by a splice or other suitable means) to a fiber optic waveguide for interferometric measurements of strain and acceleration based thereon.

The flexural discs 11A, 11B are preferably formed of a structural material such as alloys of aluminum, nickel, iron, or copper. The fiber optic sensor 10 is typically mounted inside a protective housing (not shown) that is suitable for the desired application. The housing may be manufactured by any suitable means such as machining or casting.

During operation, acceleration forces along the central axis CA cause the radially outer edge portions 29A, 29B of the two flexural discs 11A, 11B, together with the proof mass 31, to move together in a direction parallel to the central axis (denoted by arrow 36) relative to radially inner portions 15A, 15B of the two flexural discs 11A, 11B and the center support structure (central support members 13A, 13B and center post 12). Each flexural disc 11A, 11B is thin and flexible to allow for flexure of the disc between its inner and outer edges in response to such axial acceleration forces, but is quite stiff in its radial direction (i.e., the plane of the respective flexural disc). The flexibility of the axially-aligned, outer-edge-connected flexural disc arrangement together with the outer-edge-connected proof mass provide for a relatively large response to axial acceleration forces. The radial stiffness of the axially-aligned, outer-edge-connected flexural disc arrangement minimizes the response to non-axial forces. By limiting the response to non-axial forces, unwanted cross-axis sensitivity of the device is significantly reduced.

An alternate embodiment of a fiber optic sensor 10′ in accordance with the present invention is shown in FIG. 1B, which includes three flexural discs 11A′, 11B′, and 11C′ that are rigidly attached to a central support member 12′. In the preferred embodiment, the radially inner portion 15A′ of the top flexural disc 11A′ is permanently affixed to the central support member 12′ by welding, adhesive material, or other suitable means (for example, by welding along the interface 41′ therebetween), and the radially inner portion 15C′ of the bottom flexural disc 11C′ is permanently affixed to the central support member 12′ by welding, adhesive material, or other suitable means (for example, by welding along the interface 43′ therebetween). The radially inner portion 15B′ of the intermediate flexural disc 11B′ is permanently affixed between an annular flange 16′ of the central support member 12′ and a backing disc 17′ by welding, adhesive material, or other suitable means (for example, by welding along the interface 49′ through the radially inner portion 15B′ of the intermediate flexural disc 11B′ to the annular flange 16′. The backing disc 17′ interfaces to an annular shoulder 19′ of the central support member 12′. In this configuration, the three flexural discs 11A′, 11B′, 11C′ are centrally supported by rigid attachment to the central support member 12′ such that the flexural discs 11A′, 11B′, 11C′ are axially-aligned to one another.

The top flexural disc 11A′ has a top surface 21A′ opposite a bottom surface 21B′. The intermediate flexural disc 11B′ has a top surface 23A′ opposite a bottom surface 23B′. The bottom flexural disc 11C′ has a top surface 24A′ opposite a bottom surface 24B′. A fiber optic coil 25′ is affixed to the top surface 23A′ of the intermediate flexural disc 11B′ by adhesive material or other suitable means. For simplicity of illustration, the fiber optic coil 25′ is indicated as a solid part. However, it should be understood that the fiber optic coil 25′ is a multi-layer spiral-wound coil that may be formed in accordance with well-known techniques for forming such coil.

A first outer edge coupler 27A′ extends between the radially outer edge portions 29A′, 29B′ of the flexural discs 11A′, 11B′ and is rigidly attached thereto by welding, adhesive material, or other suitable means (for example, welding at interfaces 53′, 55′) such that the radially outer edge portions 29A′, 29B′ of the top and intermediate flexural discs 11A′, 11B′ are rigidly connected together. A second outer edge coupler 27B′ extends between the radially outer edge portions 29B′, 29C′ of the flexural discs 11B′, 11C′ and is rigidly attached thereto by welding, adhesive material, or other suitable means (for example, welding at interfaces 56′, 57′) such that the radially outer edge portions 29B′, 29C′ of the intermediate and bottom flexural discs 11B′, 11C′ are rigidly connected together. A first proof mass 31A′, which is preferably made of tungsten, is rigidly attached to the first outer edge coupler 27A′ and is disposed in the space between bottom surface 21B′ of the top flexural disc 11A′ and the top surface 23A′ of the intermediate flexural disc 11B′. A second proof mass 31B′, which is preferably made of tungsten, is rigidly attached to the second outer edge coupler 27B′ and is disposed in the space between bottom surface 23B′ of the intermediate flexural disc 11B′ and the top surface 24A′ of the bottom flexural disc 11C′. The proof masses 31A′, 31B′ are rigidly attached to corresponding outer edge couplers 27A′, 27B′ by adhesive material, welding, or other suitable means. In this manner, the proof masses 31A′, 31B′ are rigidly connected by the respective outer edge couplers 27A′, 27B′ to the radially outer edge portions 29A′, 29B′, 29C′ of the flexural discs 11A′, 11B′, 11C′. The additional mass provided by the outer-edge-coupled proof masses 31A′, 31B′ improves the sensitivity of the device in response to axial accelerations and the strain measurements based thereon.

The fiber optic coil 25′ of the fiber optic sensor 10′ is optically coupled (preferably by a splice or other suitable means) to a fiber optic waveguide for interferometric measurements of strain and acceleration based thereon.

The flexural discs 11A′, 11B′, 11C′ are preferably formed of a structural material such as alloys of aluminum, nickel, iron, or copper. The fiber optic sensor 10′ is typically mounted inside a protective housing (not shown) that is suitable for the desired application. The housing may be manufactured by any suitable means such as machining or casting.

During operation, acceleration forces along the central axis CA cause the radially outer edge portions 29A′, 29B′, 29C′ of the three flexural discs 11A′, 11B′, 11C′ together with the proof masses 31A′, 31B′ to move together in a direction parallel to the central axis (denoted by arrow 36′) relative to radially inner portions 15A′, 15B′, 15C′ of the three flexural discs 11A′, 11B′, 11C′ and the central support member 12′. Each flexural disc 11A′, 11B′, 11C′ is thin and flexible to allow for flexure of the disc between its inner and outer edges in response to such axial acceleration forces, but is quite stiff in its radial direction (i.e., the plane of the respective flexural disc). The flexibility of the axially-aligned outer-edge connected flexural disc arrangement together with the outer-edge connected proof mass provide for a relatively large response to axial acceleration forces. The radial stiffness of the axially-aligned outer-edge connected flexural disc arrangement minimizes the response to non-axial forces. By limiting the response to non-axial forces, unwanted cross-axis sensitivity of the device is significantly reduced.

In the preferred embodiments of the invention, the axially-aligned outer-edge connected flexural disc arrangements described herein provide an axial vibration mode (i.e., a natural mode of vibration that is excited by axial loading of the device) that has the lowest natural frequency as compared to other natural modes of vibration of the device. Moreover, the natural frequency of this axial vibration mode is less (preferably, offset by more than 5 kHz) than the lowest natural frequency of any non-axial vibration mode of the device (i.e., a natural mode of vibration that is excited by non-axial loading of the device).

A majority of mechanical systems can be made to resonate—that is, under proper conditions, vibrate with sustained, oscillatory motion. Resonant vibration is caused by the interaction between the inertial and the elastic properties of the materials within a structure. Resonant vibration occurs when one or more of the natural modes of vibration of the structure are excited. Resonant vibration typically amplifies the vibration response far beyond the level of deflection, stress, and strain caused by static loading.

Natural modes of vibration are inherent properties of a structure. Each natural mode of vibration is defined by a natural (or resonance) frequency, modal damping characteristics, and a mode shape. At or near the natural frequency of a given mode, the overall shape of the structure will tend to be dominated by the mode shape of the given mode.

The fiber optic sensor devices described herein each have an axial vibration mode, which is a natural mode of vibration that is excited by axial loading of the device. Such axial loading is applied along directions that are substantially aligned to the central axis CA of the device as depicted in FIGS. 1A and 1B. A fiber optic sensor device that uses only a single flexural disc, as extensively reported in the literature, also has two modes of vibration that occur at lower frequency than the desired axial mode, and can therefore result in unwanted resonances within the useful measurement bandwidth. These modes can be described as twisting modes, with the axis of rotation within the plane of the disc.

In the preferred embodiments of the invention, the axial vibration mode has the lowest natural frequency as compared to other natural modes of vibration of the device. Moreover, the natural frequency of this axial vibration mode is less (preferably, offset by more than 5 kHz) than the lowest natural frequency of any non-axial vibration mode of the device. These properties are dictated by the stiffness of the device to such non-axial vibration modes being significantly higher than the stiffness of the device to the axial vibration modes. These properties ensure that the non-axial vibration modes do not interfere with the operation of the device and the measurements derived therefrom. It also acts to reduce the cross-axial sensitivity of the device, and enables the use of larger proof masses, and hence higher sensitivity.

For example, the fiber optic sensors of FIGS. 1A and 1B are both preferably designed to have an axial vibration mode at a natural frequency on the order of 1400 Hz, which gives 3 dB gain flatness to 1 kHz. For the embodiment of FIG. 1A, the lowest natural frequency for all non-axial vibration modes is on the order of 10.4 kHz. For the embodiment of FIG. 1B, the lowest natural frequency for all non-axial vibration modes is on the order of 7 kHz.

Advantageously, the flexibility of the axially-aligned outer-edge-connected flexural disc arrangement together with the outer-edge-connected proof mass provide for a relatively large response to axial forces. The radial stiffness of the axially-aligned outer-edge-connected flexural disc arrangement minimizes the response to non-axial forces. By limiting the response to non-axial forces, unwanted cross-axis sensitivity of the device is significantly reduced. Moreover, the flexural disc fiber optic sensor design of the present invention has a compact form factor suitable for installation in a borehole that traverses an oil field as well as for other fiber-based interferometric measurement applications.

There have been described and illustrated herein embodiments of a flexural disc fiber optic sensor. While particular embodiments of the invention have been described, it is not intended that the invention be limited thereto, as it is intended that the invention be as broad in scope as the art will allow and that the specification be read likewise. Thus, while a particular sensor design has been disclosed, it will be understood that other designs can be used. For example, it is contemplated that the outer edge coupler(s) of the fiber optic sensor designs described herein can be realized as an integral part of the proof mass. Moreover, while particular materials and parameters have been disclosed, it will be appreciated that other materials and parameters could be used as well. It will therefore be appreciated by those skilled in the art that yet other modifications could be made to the provided invention without deviating from its scope as claimed.

What is claimed is:

1. A fiber optic sensor comprising:
a central support structure;
at least two flexural discs that are spaced apart from one another along a central axis, wherein radially inner portions of said flexural discs are rigidly attached to said central support structure;
a fiber optic coil affixed to one of said flexural discs;
at least one proof mass disposed between said flexural discs; and
coupling means for rigidly connecting together radially outer edge portions of said flexural discs and for rigidly connecting the at least one proof mass to said radially outer edge portions of said flexural discs.

2. A fiber optic sensor according to claim 1, wherein:
said coupling means comprises an outer edge coupler that is rigidly attached to radially outer edge portions of said flexural discs, and wherein
said proof mass is attached to said outer edge coupler.

3. A fiber optic sensor according to claim 2, wherein said at least one outer edge coupler is welded to radially outer edge portions of said flexural discs.

4. A fiber optic sensor according to claim 3, wherein said at least one proof mass comprises a tungsten body attached to said outer edge coupler by an adhesive.

5. A fiber optic sensor according to claim 3, wherein said at least one proof mass comprises a tungsten body attached to said outer edge coupler by welding.

6. A fiber optic sensor according to claim 3, wherein said at least one proof mass comprises a tungsten body attached to said outer edge coupler by soldering.

7. A fiber optic sensor according to claim 3, wherein said at least one proof mass comprises a tungsten body attached to said outer edge coupler by brazing.

8. A fiber optic sensor according to claim 1, wherein said central support structure comprises at least one annular portion that projects radially outward and cooperates with a corresponding backing disc to affix a respective flexural disc therebetween in order to provide for rigid attachment of the radially inner portion of the respective flexural disc to the central support structure.

9. A fiber optic sensor according to claim 1, wherein said radially inner portions of said first and second flexural discs are welded to said central support structure.

10. A fiber optic sensor according to claim 1, comprising three flexural discs that are spaced apart from one another along a central axis, wherein radially inner portions of said three flexural discs are rigidly attached to said central support structure.

11. A fiber optic sensor according to claim 1, wherein stiffness of the flexural discs to radial loads together with said coupling means provides stiffness that minimizes the response of the fiber optic sensor to non-axial forces.

12. A fiber optic sensor according to claim 1, wherein:
the fiber optic sensor has an axial vibration mode that has the lowest natural frequency as compared to other natural modes of vibration of the fiber optic sensor, and wherein
the natural frequency of said axial vibration mode is less than the lowest natural frequency of any non-axial vibration modes of the fiber optic sensor.

13. A fiber optic sensor according to claim 12, wherein the natural frequency of said axial vibration mode is at least 5 kHz less than the lowest natural frequency of any non-axial vibration modes of the fiber optic sensor.

14. A fiber optic sensor according to claim 1, wherein said fiber optic sensor includes only a single fiber optic coil.

15. A fiber optic sensor according to claim 1, wherein said fiber optic coil comprises reflectors near its start and end points.

16. A fiber optic sensor according to claim 15, wherein said reflectors are fiber Bragg gratings.

17. A fiber optic sensing system comprising:
an optical fiber waveguide; and
at least one fiber optic sensor of claim 1 integrated inline with said optical fiber waveguide.
